(19) United States
(12) Patent Application Publication
(10) Pub. No.: US 2002/0196488 A1
(43) Pub. Date: Dec. 26, 2002

(54) Recirculating frequency-stacking optical memory

(76) Inventor: Michael H. Myers, Poway, CA (US)

Correspondence Address: ALL OPTICAL NETWORKS, INC., 9440 CARROLL PARK DRIVE, SAN DIEGO, CA, 92121, US

(21) Appl. No.: 09/886,921

(22) Filed: Jun. 21, 2001

(51) Int. Cl. G02F 2/00

(52) U.S. Cl. 359/109

(57) ABSTRACT

An apparatus and method for storing optical information packets. The apparatus includes an optical circulator set up to receive and circulate an optical packet having an initial frequency and length. The circulator may include a frequency shifter which shifts the frequency of the circulating packet. The circulator may then receive a following packet at the initial frequency. The frequency shifter may then frequency-shift the circulating packets and receive a new packet. This process may be continued thereby creating a frequency-stacked signal composed of information packets at different wavelengths. On the receiving end, frequency shifters may receive the frequency-stacked signal and shift the signal until a desired packet has a desired frequency. The desired packet may then be filtered and detected for transmission. In another embodiment, a tunable filter may be used to filter out a desired packet at some arbitrary frequency.

### BACKGROUND

1. The Field of the Invention

This invention relates to optics and, more particularly, to novel systems and methods for storing optical information.

2. Background

The function of memory is a concept key to high-speed optical communication networks. As optical communications advance, the need arises for more advanced methods of storing optical information in accompaniment. In addition, in switched packet networks, the ability to store optical packets temporarily while routing and switching packets becomes necessary. Moreover, when optical packets arrive at a switching node simultaneously, it may be necessary to store selected packets for a short time until they can be forwarded to their destination.

It may be possible to store optical packets in memory by converting them to electrical signals, storing them in known electrical memory devices, and then converting them back to optical signals for transferring. However, the comparatively slower speed of electronic devices makes such a solution non-ideal.

Fiber loops may be used to function as optical memory devices by circulating optical information until forwarding. A fiber loop may be implemented to receive a string of optical information packets in series. Therefore, the loop may be designed with sufficient length to allow for the circulation therein. When a packet of information is called from the loop, the string may be circulated until the desired packet may be switched out.

However, using a simple fiber loop exclusively to store optical information has inherent problems when trying to randomly access selected data. If only selected packets of a train of optical information are needed, the entire information train within the loop must be circulated to a selected location (e.g. a serial-like operation) before the desired information can be switched out. This method is inherently inefficient and may not provide the desired speed to work in future optical networks.

What is needed an optical “random access memory” whereby packets may be circulated concurrently within a circulator at different frequencies, thereby maintaining the integrity of packet information.

What is further needed is a way to randomly access any of the packets within the circulator according to a level of priority.

What is further needed is an optical “content-addressable memory” to provide fast associative “lookups” in optical devices, such as optical routers.

### BRIEF SUMMARY AND OBJECTS OF THE INVENTION

In view of the foregoing, it is a primary object of the present invention to provide a recirculating frequency-stacking optical memory that may be used to randomly access optical information packets.

It is another object of the invention to provide a tunable system that may be used to optically select desired information packets according to a level of priority.

It is a further object of the invention to provide a way to evenly distribute energy across the spectrum of lasers having an uneven distribution of spectral energy.

It is another object of the invention to provide an optical-content-addressable memory which may be used in high-speed optical communications to perform “lookups” of associated data.

It is a further object of the invention to provide an apparatus and method, using optical gates of various types, to logically compare an incoming input pattern to a stored list of possible input patterns.

It is a further object of the invention to ensure that incoming data bits arrive at the optical gates with the proper timing.

Consistent with the foregoing objects, and in accordance with the invention as embodied and broadly described herein, a method and apparatus are disclosed in one embodiment of the present invention as including a circulator set up to circulate incoming optical data packets having an initial frequency and length. The circulator may include a frequency shifter to shift the frequency of the circulating packet before receiving a new incoming packet. All circulating packets may be subsequently shifted again and a new packet received. This process may continue until a frequency-stacked signal is circulating with the circulator. A high or low pass filter may also be included within the circulator to filter out packets that exceed or fall below a selected frequency.

Shifting may be stopped at some point or the shifting may continue, and packets not accessed within a specified time may be shifted out of the range of the high or low pass filter. A frequency-shift controller may be set up to control the frequency shifter and turn the shifting on or off according to the arrival of incoming packets.

The circulator may also include an amplifier to reduce signal attenuation within the circulator. This may provide an advantage by extending the life span of any signals circulating therein.

On the receiving end, the frequency-stacked signal may be received by a plurality of frequency shifters set up to shift the frequency-stacked signal according to the frequency of a desired packet. Once the desired packet is at a desired frequency, a filter may be used to filter out the packet from the frequency-stacked signal.

In another embodiment, a desired packet may simply be filtered out at whatever shifted frequency value it might have at the time. In certain embodiments, a tunable filter may be used to tunably select one of the packets from the frequency-stacked signal. This filtered packet may be detected by a detector and re-modulated onto a laser having a selected frequency, if desired.

The circulator of the present invention may also be used for other purposes in accordance with the invention. For example, in certain lasers having a spectrum made up of energy spikes spaced at equal intervals, the present invention may be used to fill in the gaps between the spectral spikes. This may be done by setting the frequency shifter to shift the frequency by approximately the width of each spectral spike. By having an even distribution of energy, a laser may be used as a narrowband laser and dispersion may be reduced. This technique may be called “spectral folding” and may facilitate denser packing of multiplexed signals.

In selected embodiments, it may be desirable to have an optical memory addressable by content that may be used to work with high speed communications devices, such as routers. An optical-content-addressable memory may be set up to receive an electrical input, but may operate optically. An optical-content-addressable memory may receive an input pattern electronically into arrays of optical gates. The optical gates may be set up to compare the incoming input pattern to stored patterns. If a match is found, the corresponding optical gates may be set up to open and transmit a laser or light signal corresponding to an output pattern. This output pattern may be transmitted optically and converted back to an electrical output pattern by a series of detectors, if desired.

In certain embodiments, The light signal emitted from the optical gates may be used to illuminate an output pattern on a light-masking screen. This screen may be a programmable LCD screen in certain embodiments.

In another embodiment, the content-addressable memory may consist of multiple arrays of optical gates. Each array may correspond to a single bit of an output pattern. In addition, each array may have all stored patterns which make its corresponding bit equal to a “1.” In this manner, an output pattern may be constructed bit-by-bit by the input pattern received by each array.

The optical gates used to compare the input patterns to stored patterns may be optical Mach-Zehnder modulators. In addition, other optical gates may be used with the present invention such as polarization rotators, or optical gates of other technologies.

To ensure that the incoming input patterns arrive at the optical gates with the proper timing, the incoming bits may be pipelined or delayed. This may be done by placing delay devices in line with the incoming bits.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a recirculating frequency-stacking optical memory in accordance with the invention;

FIG. 2 is a schematic block diagram of one embodiment of a tunable filter usable with the apparatus of FIG. 1;

FIG. 3 is a graph illustrating one use of the present invention wherein the spectrum of a laser is frequency-shifted to provide a more even energy distribution;

FIG. 4 is a schematic block diagram illustrating the layout of a RAM (random access memory) and a CAM (content-addressable memory);

FIG. 5 is a schematic block diagram illustrating one example of the input and output of a CAM;

FIG. 6 is a schematic block diagram illustrating an alternative way to implement a CAM;

FIG. 7 is a schematic block diagram of Mach Zehnder modulators used as optical gates in accordance with the present invention;

FIG. 8 is a schematic block diagram of one embodiment of an optically operated CAM in accordance with the present invention;

FIG. 9 is a schematic block diagram of one alternative embodiment of an optically operated CAM in accordance with the present invention;

FIG. 10A is a schematic block diagram of one alternative embodiment of an optical gate using polarizing screens;

FIG. 10B is a schematic block diagram of another alternative embodiment of an optical gate for use in implementing the present invention;

FIG. 10C is a schematic block diagram of one embodiment of an optical gate using a shift register for use in implementing the present invention; and

FIG. 11 is a schematic block diagram illustrating one embodiment of an apparatus wherein signals are timed to arrive at the optical gates using delays.

### DETAILED DESCRIPTION OF THE PREFERRED EMBODIMENTS

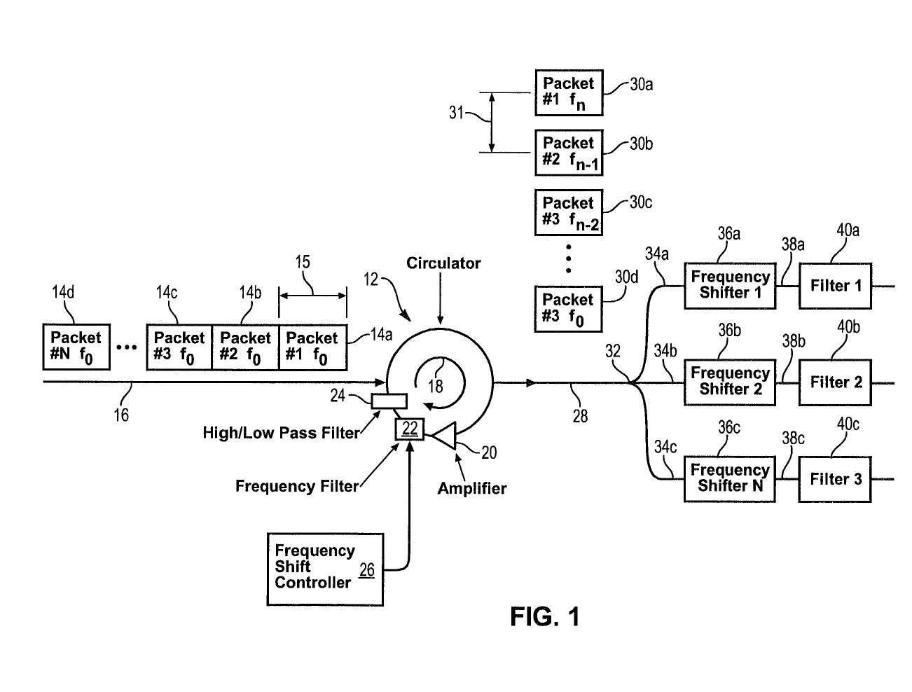

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 13, is not intended to limit the scope of the invention, as claimed, but is merely representative of certain presently preferred embodiments of an apparatus and method in accordance with the invention.

The presently preferred embodiments will be best understood by reference to the drawings, wherein like parts are designated by like numerals throughout. Those of ordinary skill in the art will, of course, appreciate that various modifications to the detailed schematic diagrams of FIGS. 1 through 13 may easily be made without departing from the essential characteristics of the invention. Thus, the following description of FIGS. 1 through 13 is intended only by way of example, and simply illustrates certain presently preferred embodiments of an apparatus and method that is consistent with the invention as claimed herein.

Referring to FIG. 1, an apparatus 10 may include a circulator 12 arranged to circulate optical signals, thus maintaining or storing an optical signal for some arbitrary time. A circulator 12 may be designed to have a specified time or length for a single circulation 18 of an optical signal rotating therein. In addition, the circulator 12 may circulate multiple signals at different frequencies concurrently.

For example, a circulator 12 may be arranged to receive an optical signal 14a-d comprising packets 14a-d having some arbitrary packet length 15 and frequency f₀. The circulator 12 may be configured to have a circulation time 18 at least as long as a packet length 15. A packet 14a may enter the circulator 12 and circulate therein until reaching a frequency shifter 22 configured to frequency shift the packet 14a to a new frequency f₁ corresponding to a selected spacing 31.

Another packet 14b at frequency f₀ may then be received into the circulator 12. Both packets 14a, 14b may then be circulated concurrently at different frequencies. After another circulation time 18, both packets 14a, 14b may then be shifted by the frequency shifter 22 and another packet 14c received into the circulator 12.

The sequential frequency shift and reception of data packets 14a-d may produce a frequency-stacked signal 30 circulating within the circulator, each packet 30a-d having a different frequency. Thus, the circulator 12 may circulate numerous packets 30a-d while maintaining the signal integrity of each packet 30a-d.

A circulator 12 may include other components such as an amplifier 20, and a high or low pass filter 24. In certain embodiments, a circulator 12 may have an amplifier 20 to maintain the signal strength of each packet 14a-d within the circulator 12. Thus, the time that packets 14a-d may be circulated may be extended and signal degradation may be reduced.

Certain components, such as the frequency shifter 22, may not be perfectly linear devices and may introduce distortion into the frequency-stacked signal 30. Thus with each successive circulation, the signals 30a-d may become more distorted making the device a somewhat transient device. In certain embodiments, other types of waves, such as sawtooth waves, may be used to reduce distortion that may be introduced by devices such as the frequency shifter 22.

A circulator 12 may also include a high or low pass filter 24 to filter out any packets above or below a certain frequency. Therefore, the signal power within the circulator 12 may be bounded. Furthermore, packets 30a-d must be accessed or read within a finite time period before the signal is shifted out of the frequency range of the filters 24.

In certain embodiments, the apparatus 10 may also include a frequency shift controller 26 to control the frequency shifter 22. Thus, the amount of shift may be controlled. In certain embodiments, the shifter may be turned off while the circulator 12 is waiting to receive another packet 14. The controller 26 may also be used to shift packets 30 up or down as needed.

In certain embodiments, the frequency-stacked signal 30 may be output on line 28 to a splitter 32. The splitter 32 may split the signal 28 into daughter signals 34a-c, each daughter signal 34 being identical. A daughter signal 34a may be subsequently received by a frequency shifter 36a and shifted to a desired frequency falling within the passband of a filter 40a.

Consequently, any selected packet 30a-c may be passed by the filter 40a and the information therein retrieved. Likewise, other frequency shifters 36b-c and filters 40b-c may be arranged to filter out other packets 30a-d from the frequency stacked signal 30. Thus, the apparatus 10 may effectively function as an optical random access memory.

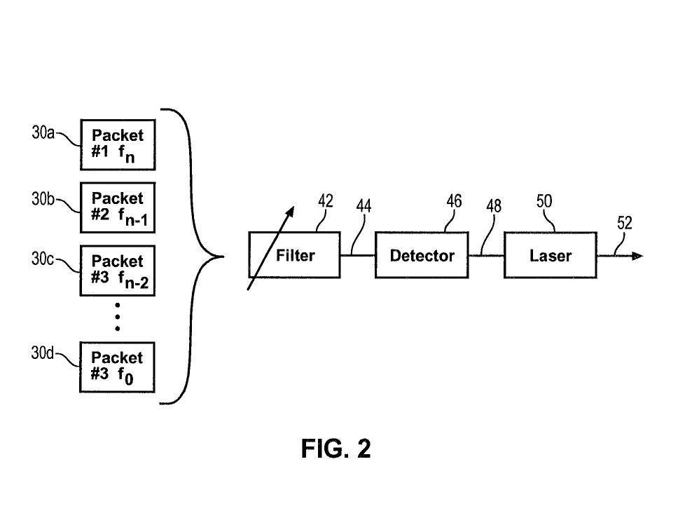

Referring to FIG. 2, in an alternative embodiment, the apparatus 10 may include a tunable filter 42 set up to be tunable in the frequency range f₀-fₙ of packets 30a-d. The filter 42 may be tuned to pass any selected packet 30, thus further enabling the device to function as a random access memory. Accordingly, a detector 46 may be arranged to receive the filtered signal 44 from the filter 42. The resulting detected signal 48 may be modulated onto a laser 50 having a selected frequency. Thus, any of the packets 30a-d may be detected and output at a selected frequency, such as at the original frequency f₀.

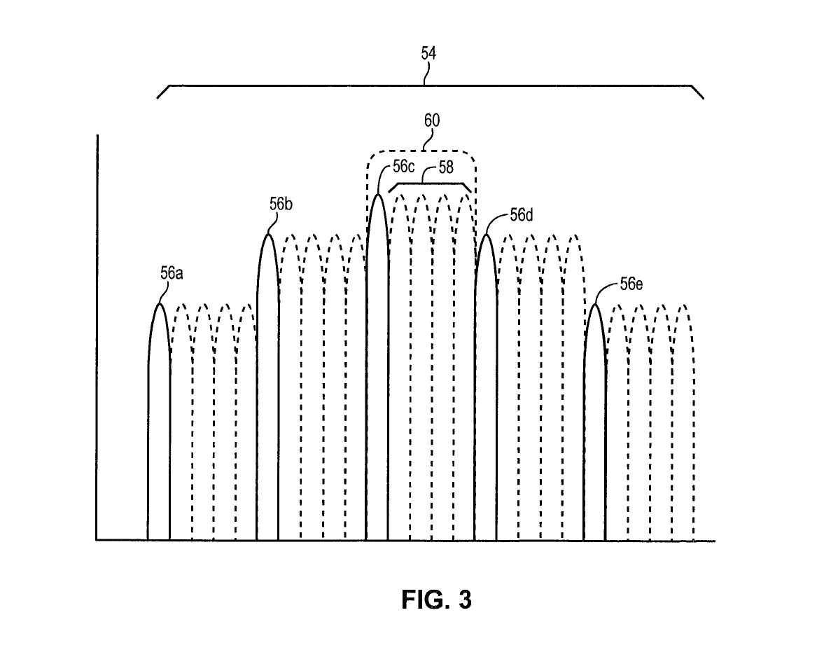

Referring to FIG. 3, while continuing to refer generally to FIG. 1, in certain embodiments, the circulator 12 of apparatus 10 may be used with certain types of lasers, such as Fabry-Perot lasers, which may have a spectral shape 54 having spectral spikes 56a-e. The circulator 12 may be set up with a very short delay 18 and arranged so that the frequency shifter 22 may frequency-shift the spectrum 54 in order to fill in the gaps between the spikes 56a-e.

For example, the frequency shifter 22 may shift the spike 56c to form adjacent spikes 58. Thus, the energy of the spectrum 54 may be distributed more evenly and across more of the range or the entire range of the spectrum 54. One advantage of this is that dispersion effects of a laser may be reduced, thus providing a narrower band laser. In addition, this may facilitate the use of narrower filters and denser packing of data in multiplexed signals.

The issue of speed as pertaining to memory may be furthered by a consideration of CAM (content addressable memories) versus RAM (random access memories). When comparing the different paradigms of memory, the idea of a CAM arises, in part, from the desire to have a memory system that works on an intuitive level, much in the way a human might think. In other words, the memory should be associative in nature. Some arbitrary piece of information should be capable of being referenced with respect to another arbitrary piece of information.

In a CAM, two types of information are stored in memory, which may be named a “key” and an “association”. When a key is presented to the memory, all the memory locations are scanned to find a match for the key. If one is found, the corresponding association is returned. Thus, the Cam provides a very intuitive memory device.

In a typical RAM, memory cells are indexed by rows and columns. A RAM may be arranged to receive an address on one bus and return the data contents located at that address on another bus. As a result, RAM is typically much cheaper and much denser than a CAM. In addition, RAM access time is also typically less than that for a comparable CAM.

In order to make RAM function more intuitively, like a CAM, software may be used as the primary facilitator. A whole host of software applications including neural networks, data structures, databases, as well as others may adapt RAM to function in an associative fashion. In order to achieve this, many more processor cycles and RAM accesses would be required. Fortunately, processor speed has advanced fast enough to keep pace with the requirements of making a RAM function like a CAM. Nevertheless, using a RAM to make simple searches based on associations occupies an inordinate amount of system resources.

With regard to high-speed optical communications, an optical CAM may prove to be very useful in high-speed communications devices, such as routers, where associative “lookups” are used extensively. Furthermore, in speed-critical networks, it would be advantageous to keep processing time at a minimum. Thus, optical RAM implementations in this context might not be desirable. Nevertheless, in other implementations, an optical RAM may be the device of choice.

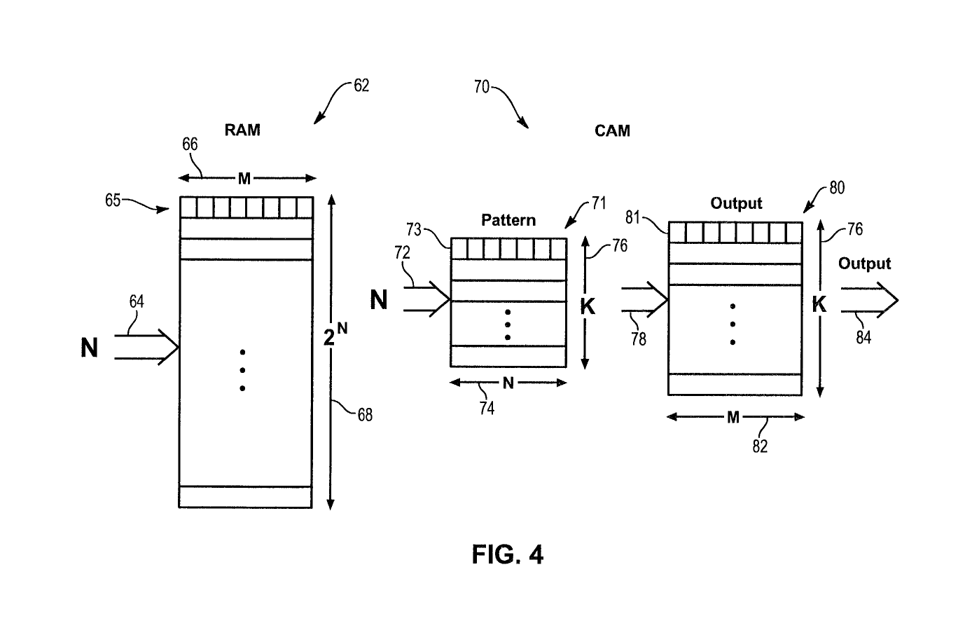

Referring to FIG. 4, a RAM 62 (random access memory) and a CAM 70 (content-addressable memory) are illustrated. In certain applications, it may be desirable to have a memory that works in a more intuitive manner, such as the way the human mind functions.

Thus, an input is able to be translated into an associated output. For this reason, a CAM 70 may have advantages in certain applications over a comparable RAM 62.

In general, a RAM 62 is set up to receive an “N” bit address 64 corresponding to a memory location 65 having “M” bits 66. The result is a memory device 62 with a unique memory location 65 for each unique address 64. The product of this is typically a memory device 62 with 2^{N} memory locations. As a result, the exponential quantity of required memory locations may create an excess of reserved memory in applications with a much more limited number of inputs and associated outputs. This may be a very inefficient use of memory resources in many cases.

Moreover, the way a typical RAM device 62 accesses information uses an address line to indicate a memory location. Such an approach is quite non-intuitive and generally requires a software layer to make the device 62 function in a more associative manner. As a result, the process is slowed by an inordinate number of processor cycles and RAM accesses. In speed-critical applications, such as optical communications, a CAM 70 may provide faster service and be easier to implement than a RAM device 62.

A CAM 70 may be arranged to receive an input pattern 72 having “N” bits. The input pattern 72 may be compared to an array 71 of “K” input patterns 76, such as a pattern 73. If a match is found, a corresponding output pattern is located from an array 80 of “K” output patterns, such as the output pattern 81, each output pattern having “M” bits. The output pattern may subsequently be transmitted through the output 84. Thus the CAM 70 acts in an intuitive way by linking an input pattern 72 with an associated output pattern 84. Moreover, the number of memory locations needed for operation of the CAM 70 is greatly reduced from that of the RAM 62.

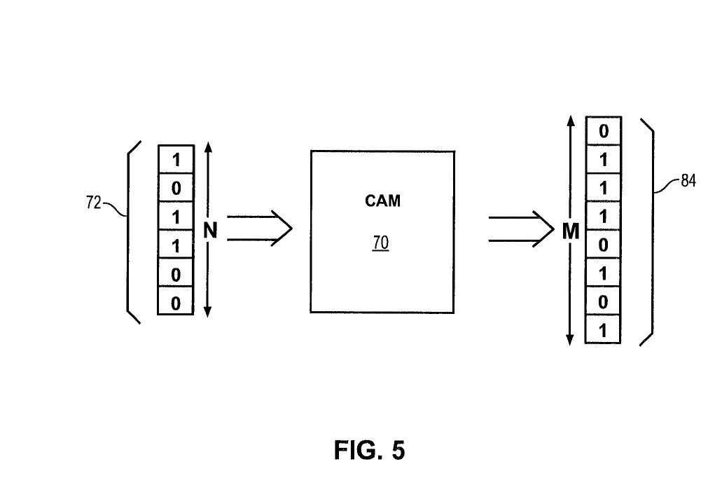

Referring to FIG. 5, for example, a CAM 70 may receive an input bit pattern 72 having “N” input bits. The CAM 70 may compare the input pattern 72 to an internal array of input patterns. If the input pattern 72 is found, the CAM 70 locates and outputs an associated output pattern 84 having “M” bits.

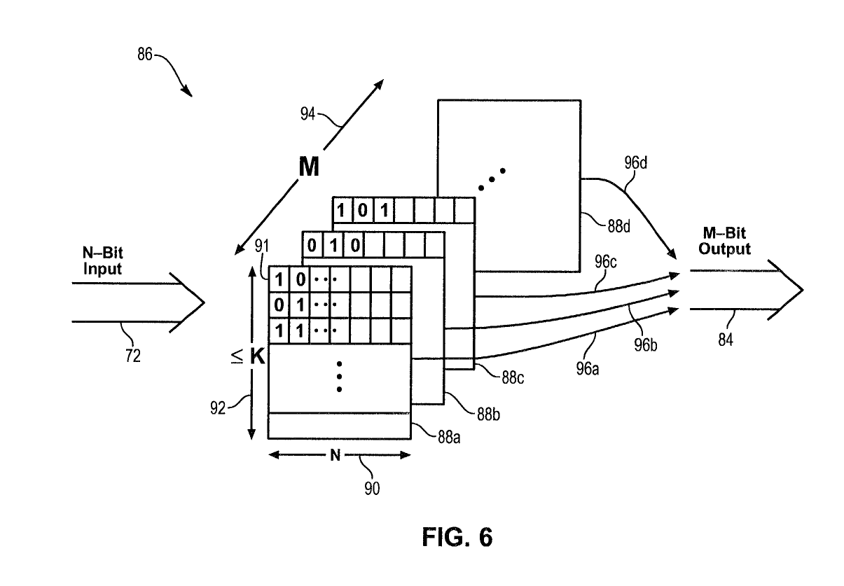

Referring to FIG. 6, an alternative way to implement a CAM 86 is illustrated. A CAM 86 may be arranged to include a plurality of “M” arrays 88a-d. Each array 88 corresponds to a bit of an “M” bit output pattern. Each array 88 may contain a list of all input patterns, such as the input pattern 91, that cause the corresponding bit of the output pattern 84 to be a “1.” Typically, each array 88 may contain less than the “K” possible input patterns for which the CAM 86 will return an output pattern 84. If an input pattern is found in the array 98, then a “1” is output on a line 96 corresponding to that bit.

For example, the CAM 86 may receive an “N” bit input pattern 72. The input pattern 72 may be compared to stored input patterns contained within an array 88a and if located, a “1” will be output on line 96a corresponding to one bit of an output pattern 84. Likewise, if the stored input pattern 72 is not found in the array 88a, then a “0” will be output on line 96a.

In similar fashion, the other arrays 88b-c will compare the input pattern 72 to their respective lists of stored input patterns, and if a match is located, the array 88 will output a “1” to each of the respective bits of the output pattern 84. Thus, the bits of the output pattern 84 will be constructed bit-by-bit by the output of each line 96a-d originating from the “M” arrays 88a-d.

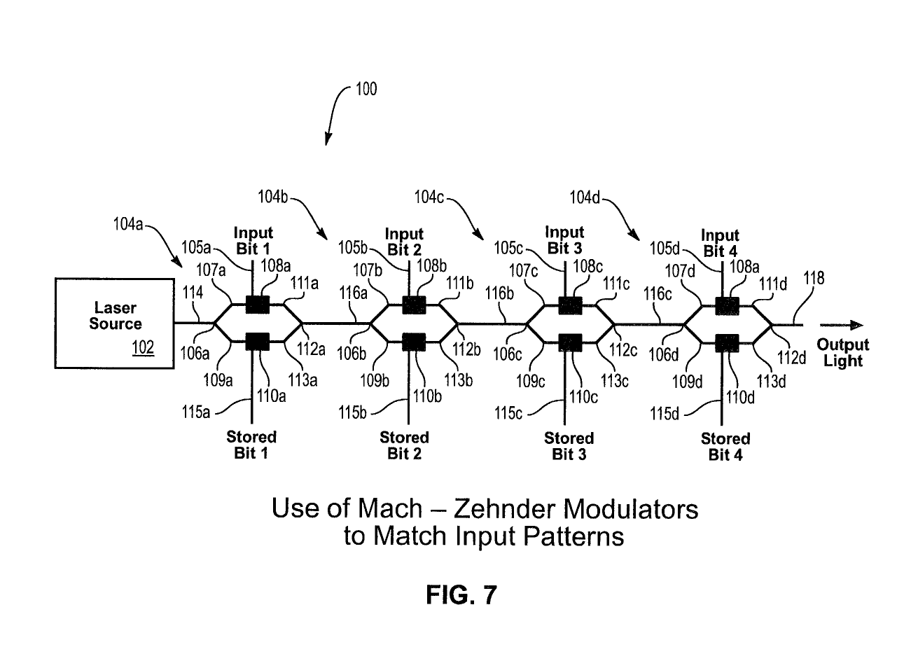

Referring to FIG. 7, chains of Mach-Zehnder modulators 104a-d may be used by the present invention to compare an input pattern 105a-d to a stored input pattern 115a-d. The chain 100 may receive both the input pattern 105a-d and the stored input pattern 115a-d as electrical inputs. These electrical inputs may control the Mach-Zehnder modulators 104a-d, used as optical gates 104a-d.

For example the chain 100 may include a laser source 102 used to provide a laser or optical beam 114. The optical beam 114 may be received by a Mach-Zehnder modulator 104a at an input 106a where it is split into two legs 107a, 109a. Each electrical input 105a, 115a may control the phase retardation of a respective leg 107a, 109a at modulators 108a, 110a, thereby producing outputs 111a, 113a. If the voltage state of the two inputs 105a, 115a match, light 114 passes through the modulator 104a with little attenuation. If the voltage state of the inputs 105a, 115a differs by a prescribed amount, the light 114 is strongly attenuated and is essentially turned off.

Likewise, each successive modulator 104b-d is turned on or off depending on the voltage states of inputs 105b-d and 115b-d. If any one of the modulators 104a-d does not have matching inputs 105a-d, 115a-d, light will not propagate through the chain 100. Thus, an output light signal 118 will only be achieved if all input bits 105a-d match all stored bits 115a-d.

In reality, the present invention may use any of a variety of optical gates 104a-d to switch the light source 114 on or off. The use of Mach-Zehnder modulators represents only one particular embodiment contemplated by the inventor to compare input bits 105a-d to stored bits 115a-d. Other examples and methods of implementing optical gates 104a-d will be discussed hereinbelow.

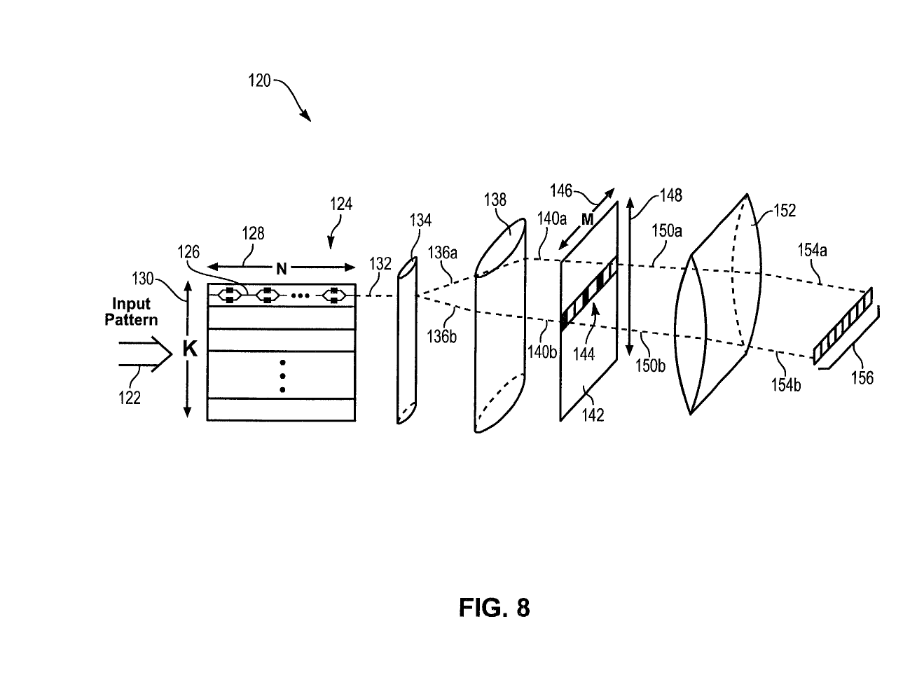

Referring to FIG. 8, in certain embodiments, a CAM 120 may be arranged to receive an input pattern 122. The input pattern 122 may be received by an array 124 of chains 126 of Mach-Zehnder modulators, such as were previously described with respect to FIG. 7. Each chain 126 of Mach-Zehnder modulators may be set up to compare the input pattern 122 to a different stored input pattern. If a stored input pattern matches the input pattern 122, an optical beam may be emitted from a chain of Mach Zehnder modulators, such as the optical beam 132 emitted from the chain 126.

A cylindrical lens 134 may be aligned to receive the optical beam 132 and spread the beam into a plane defined by edges 136a, 136b. A second cylindrical lens 138 may be aligned to collimate the light received from the lens 134 into a collimated plane defined by edges 140a-140b. A light masking screen 142 may be optically aligned so that an output pattern 144 is illuminated by the light defined by edges 140a, 140b. The optical output pattern 144 may be made up of a series of “M” bits 146 defined by light and dark areas used to represent bits of the output pattern.

A light area may represent a “1,” whereas a dark area may represent a “0.” Likewise, the light masking screen 142 may have other output patterns (not shown) arranged on the screen 142 in the directions 148. In certain embodiments, the light masking screen 142 may be a programmable LCD screen 142, which may be reprogrammed with different output patterns 144.

The filtered output pattern 144, as defined by light beam edges 150a-b, may be reflected by a lens 152 into a reflected beam defined by edges 154a, 154b onto a series of detectors 156. In certain embodiments, the detectors 156 may be photo-diodes set up to detect light and dark bits representing digital high and low bits. The detectors may be set up to convert the optical output pattern 144 to an electrical output pattern.

The embodiment of FIG. 8 demonstrates a free-space arrangement of the present invention. In reality, the function of the lenses 134, 138, 152 in guiding the light beams may also be implemented using optical fibers or waveguides in a non-free-space environment. Thus, the actual configuration illustrated may be modified considerably if optical fibers or waveguides are used.

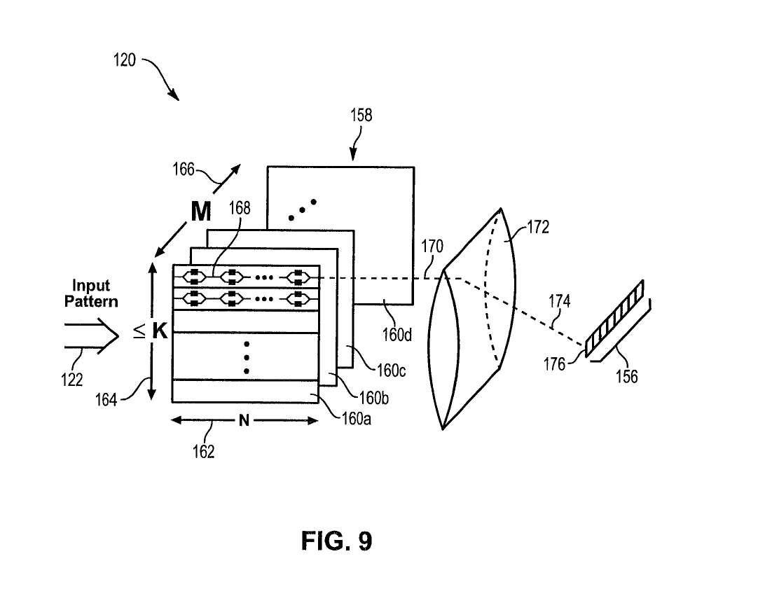

Referring to FIG. 9, an alternative embodiment of a CAM 120 may include a plurality of “M” arrays 160a-d, each array 160 having chains of Mach-Zehnder modulators, such as the chain 168 in the array 160a. As described previously for FIG. 6, each array 160 contains chains of modulators corresponding to input patterns which will cause a corresponding bit of an “M” bit output pattern to be a “1.” Each array 160 will have a number of chains equal to or less than the total number “K” of possible input patterns.

For example, an input pattern having “N” bits may be received by a chain of Mach-Zehnder modulators within an array 160a, such as chain 168. If the stored input pattern of chain 168 matches the input pattern 122, an optical beam 170 may be emitted. A lens 172 may be aligned to reflect the beam 170 onto a detector 176 corresponding to a bit 176 of a series 156 of detectors, the detectors 156 corresponding to an output pattern 156. Likewise, each of the other arrays 160b-d may also receive the input pattern 122 and output a corresponding bit to the detectors 156 through lens 172.

FIG. 9 illustrates a free-space embodiment of the present invention. However, as described previously for FIG. 8, the CAM 120 may also be implemented using optical fibers or waveguides to guide the light beams 170, 174.

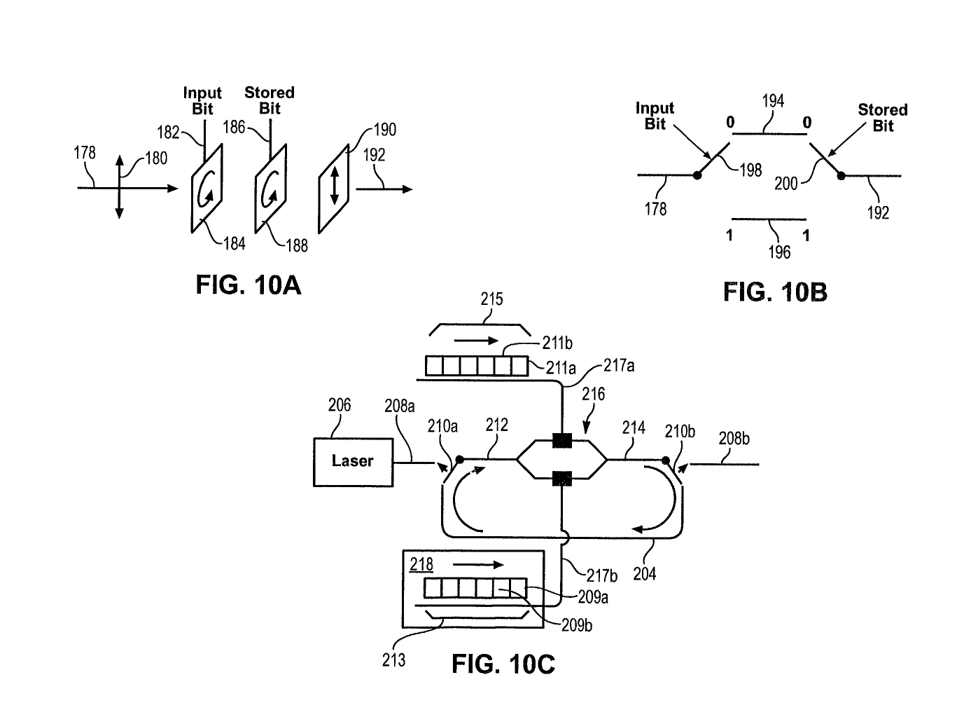

Referring to FIG. 10A, in certain embodiments, other optical gates may be substituted for the Mach-Zehnder modulators in the present invention. For example, an optical beam 178 may be polarized to a selected plane. For example, a beam 178 may be polarized vertically in the plane defined by the arrows 180. A pair of polarization rotating elements 184, 188 may be aligned to receive the incoming beam 178.

The polarization element 184 may rotate the polarization of the incoming beam 180 by 90° for a high input bit 182. It may leave the polarization unchanged for a low input bit 182. Likewise, the polarization element 188 may rotate the polarization of an incoming beam 180 by 90° for a high stored bit 186. Likewise, it may leave the polarization unchanged for a low stored bit 186.

Only if both the input bit 182 and the stored bit 186 are high or both are low will the polarization of the beam 180 remain unchanged (e.g. vertically polarized). Otherwise, the polarization will be rotated by 90°. Each polarization element 184, 188 may be followed by a polarizer 190 to select for the unchanged polarization. The beam 192 may then be forwarded to the next optical gate in the chain.

Referring to FIG. 10B, in another embodiment, optical switches of any technology may be arranged to receive an optical input beam 178. An input bit may control a switch 198 set up to create an optical path to a bus 194 for a “0” bit or to a bus 196 for a “1” bit. Likewise, a stored bit may control a switch 200 set up to create an optical path to the bus 194 for a “0” bit or to the bus 196 for a “1” bit. Thus, only when both the input bit 198 and the stored bit 200 match is an optical path created through bus the 196 or bus 200. Only then is light allowed to pass through to the output 192.

Referring to FIG. 10C, in an alternative embodiment, if an input pattern 215 is naturally arriving in serial fashion, a chain of modulators 216 or optical gates 216 may be condensed down to a single modulator 216 or optical gate 216. Light may be received from a laser 206 or light source 206 through a channel 208a into a recirculating or reflecting loop 204. Switches 210a, 210b may be used to switch light in and out of the loop 204. Light may enter into the loop through the switch 210a and circulate once for each bit 211 of an input pattern 215.

A shift register 218 may be set up to time the arrival of each stored bit 209 with each incoming input bit 211 at the gate 216. Each time through, a new input bit 211 and a corresponding stored data bit 209 of a stored pattern 213 cause the gate 216 to remain open if a match occurs.

After light is circulated through the loop 204, the process changes. For each bit of an input pattern 215 and corresponding stored pattern 213 light may be switched out of the loop 204 by a switch 210b for detection. In certain embodiments, amplification may be included within the loop 204 to compensate for losses.

For example, a light signal 208a may be received into the circulating loop 204 through the switch 210a and enter the modulator 216 or gate 216. Once light has passed through the gate 210a, the switch 210a may then switch back to complete the loop 204. An input bit 211a and a stored bit 209a may be timed to arrive at the modulator 216 or gate 216 and open the gate 216 if a match occurs. If a match occurs, light may be transmitted through to output 214 and continue circulating through the loop 204. A second input bit 211b and a stored bit 209b may be timed to arrive at the gate 216 and open it if a match occurs, thereby permitting the recirculating light to pass through.

This process may continue until the entire input pattern 215 is compared to the stored pattern 213. If any of the bits 211 do not match the bits 209, then the gate 216 will be closed and the light blocked. If all of the bits 211 match the stored bits 209, then the light will circulate through the loop. Once the input pattern 215 is compared to the stored pattern 213 and a match is established, the light may be switched out of the loop 204 by a switch 210b to an output 208b. Therefore, light will only be passed through to output 208b if a match occurs.

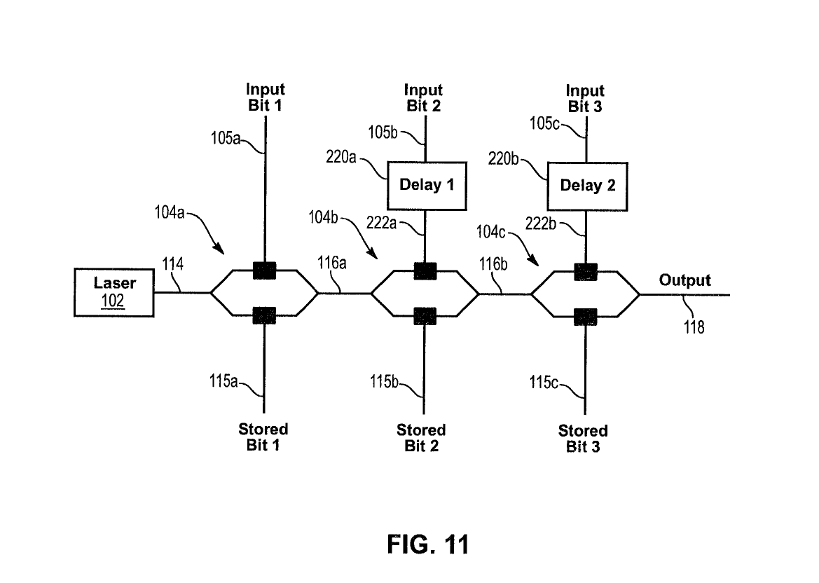

Referring to FIG. 11, light will take a finite time to propagate through a chain of optical gates 104a-c or modulators 104a-c. However, operation may occur at the maximum speed of the modulator or switch by pipelining the operation. This may require that the incoming data bits 105a-c arrive at the modulators 104a-c or switches 105a-c with the proper timing.

For example, a laser 102 may provide an optical beam 114 to a first gate 104a. An input bit 105a matching stored bit 115a may open the gate 104a, therefore providing an optical beam at the output 116a. A delay device 220a may be set up to delay the input bit 105b to provide a delayed input bit 222a, thereby opening the gate 104b with the correct timing to receive the output 116a. Accordingly the optical beam 116a may be passed through the gate 104b, therefore providing an optical beam at output 116b.

In a similar manner, a second delay device 220b may be set up to delay the input bit 105c to provide a delayed input bit 222b, thereby opening the gate 104c with the correct timing to receive output 106b. Thus, by pipelining the bits 105a-c, the gates 104a-c may be opened and light passed therethrough in an efficient manner.

From the above discussion, it will be appreciated that the present invention provides a recirculating frequency-stacked optical memory which may be used to randomly access optical information packets. In addition, the present invention provides an optical-content-addressable memory that may also be used in high-speed optical communication devices. These may be used in diverse optical communication devices, including routers where information must be disassembled and reorganized in order to be re-transmitted to a correct destination.

The present invention may be embodied in other specific forms without departing from its essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for optically storing information, the apparatus comprising:
a first input line configured to transmit first and second optical information at a first frequency;
a recirculating loop configured to receive and circulate the first optical information from the first input line;
a first frequency shifter connected in the recirculating loop and configured to frequency-shift the first optical information; and
the recirculating loop, further configured to provide a frequency-stacked signal by receiving and circulating the second optical information concurrently with the first optical information.

2. The apparatus of claim 1, further comprising:
the first frequency shifter, further configured to frequency-shift the frequency-stacked signal; and
the recirculating loop further configured to integrate a third optical information into the frequency-stacked signal by receiving and circulating a third optical information at the first frequency.

3. The apparatus of claim 2, further comprising:
a second frequency shifter connected to re-locate the first optical information at the first frequency by shifting the frequency-stacked signal; and
a third frequency shifter connected to re-locate the second optical information at the first frequency by shifting the frequency-stacked signal.

4. The apparatus of claim 3, further comprising:
a first filter operably connected to pass substantially only the first optical information from the frequency-stacked signal; and
a second filter operably connected to pass substantially only the second optical information from the frequency-stacked signal.

5. The apparatus of claim 4, further comprising an amplifier connected in the recirculating loop, the amplifier configured to amplify the frequency-stacked signal to reduce signal degradation.

6. The apparatus of claim 5, further comprising a frequency shift controller connected to control the first frequency shifter.

7. The apparatus of claim 6, wherein the recirculating loop further comprises a low pass filter configured to reduce signals corresponding to any frequencies above a limiting frequency.

8. The apparatus of claim 6, wherein the recirculating loop further comprises a high pass filter configured to reduce signals corresponding to any frequencies below a limiting frequency.

9. The apparatus of claim 2, further comprising a tunable filter operably connected to pass at least one of the first, second, and third information selected from the frequency-stacked signal.

10. The apparatus of claim 9, further comprising a detector and a laser, the detector operably connected to receive the information from the tunable filter and configured to modulate the laser therewith.

11. A method for storing optical information, the method comprising:
receiving first and second optical information, each having a first frequency associated therewith;
receiving and circulating the first optical information within a circulating loop;
frequency-shifting the first optical information; and
receiving and circulating the second optical information within the circulating loop to provide a frequency-stacked signal containing the first and second optical information.

12. The method of claim 11, further comprising:
frequency-shifting the frequency-stacked signal; and
providing a third optical information to the circulating loop and integrating the third optical information in the frequency-stacked signal.

13. The method of claim 12, further comprising:
receiving the frequency-stacked signal from the circulating loop;
frequency-shifting the frequency-stacked signal to re-locate the first optical information at the first frequency;
receiving the frequency-stacked signal from the circulating loop; and
frequency-shifting the frequency-stacked signal to re-locate the second optical information at the first frequency.

14. The method of claim 13, further comprising filtering the frequency-stacked signal to extract therefrom the first optical information and the second optical information.

15. The method of claim 14, further comprising amplifying the frequency-stacked signal to reduce signal degradation.

16. The method of claim 15, further comprising controlling, by a frequency-shift controller, the frequency-shifting within the circulating loop.

17. The method of claim 16, further comprising low-pass filtering the frequency-stacked signal to reduce any frequencies above a pre-selected frequency.

18. The method of claim 16, further comprising high-pass filtering the frequency-stacked signal to reduce any frequencies below a pre-selected frequency.

19. The method of claim 12, further comprising:
receiving the frequency-stacked signal from the circulating loop;
tuning a filter therefor; and
filtering, by the tunable filter, at least one of the first, second, and third optical information from the frequency-stacked signal.

20. The method of claim 19, further comprising:
detecting the selected optical information; and
modulating a laser in accordance therewith.
